(19) United States
(12) Patent Application Publication
(10) Pub. No.: US 2021/0245416 A1
(43) Pub. Date: Aug. 12, 2021

(54) STRETCH BLOW MOULDING METHOD FOR MANUFACTURING A PLASTIC CONTAINER AND A PLASTIC CONTAINER WHICH IS MANUFACTURED IN A STRETCH BLOW MOULDING METHOD

(71) Applicant: ALPLA Werke Alwin Lehner GmbH & Co. KG, Hard (AT)

(72) Inventor: Adem DEMIR, Lauterach (AT)

(73) Assignee: ALPLA Werke Alwin Lehner GmbH & Co. KG, Hard (AT)

(21) Appl. No.: 17/157,246

(22) Filed: Jan. 25, 2021

Related U.S. Application Data
(63) Continuation of application No. PCT/EP2019/064586, filed on Jun. 5, 2019.

(30) Foreign Application Priority Data
Jul. 25, 2018 (CH) 00921/18

(51) Int. Cl. B29C 49/76; B65D 1/02; B29C 49/12; B29C 49/42; B29C 49/48; B29C 49/64

(52) U.S. Cl. CPC B29C 49/76; B65D 1/0246; B29C 49/12; B29C 49/4273; B29K 2101/12; B29C 49/64; B29C 2793/0027; B29C 2793/009; B29B 2911/14426; B29C 49/4815

(57) ABSTRACT

A stretch blow moulding method for manufacturing a plastic container, wherein a preform, configured in an essentially tubular manner with a neck part, is inserted into a mould cavity of a blow moulding tool of a stretch blow moulding machine. The preform is stretched with a stretching mandrel and is inflated in accordance with the mould cavity by overpressure with a fluid. A dome connects onto a container section which is provided with at least one structure which projects or recedes with respect to the container wall and is separated away. With the stretch blow moulding method, at least one section of the structure is axially compressed to a settable extent within the mould cavity before the plastic container is removed from the mould.

### RELATED APPLICATIONS

This application claims priority as a continuation application under 35 U.S.C. §120 to PCT/EP2019/064586, which was filed as an International Application on Jun. 5, 2019 designating the U.S., and which claims priority to Swiss Application 00921/18 filed in Switzerland on Jul. 25, 2018. The entire contents of these applications are hereby incorporated by reference in their entireties.

### FIELD

The present disclosure relates to a stretch blow moulding method for manufacturing a plastic container. The present disclosure also relates to a plastic container which is manufactured in a stretch blow moulding method.

### BACKGROUND INFORMATION

A large number of the plastic containers which are applied nowadays, in particular plastic bottles and the like, are manufactured in a stretch blow moulding method. Concerning the stretch blow moulding method a so-called preform, which can have a design of a small tube which at its one longitudinal end includes a base and at its other longitudinal end includes a neck region with shaped-out threaded sections or the like, is inserted into a mould cavity of a blow mould and is inflated by a medium which is blown in at an overpressure. The preform is additionally stretched in the axial direction by a stretching mandrel which is moved in through the neck opening. The finished, stretch-strengthened plastic container is then removed from the blow mould after this blowing and stretching procedure.

The raw material which is applied for the manufacture of plastic containers in the stretch blow moulding method is polyethylene terephthalate (PET). PET on account of the high stretching which is carried out in the stretch blow moulding method has very good mechanical strength values and barrier characteristics as well as a high thermal durability. For example, a total stretching factor of up to 20 is achieved in the stretch blow moulding methods of PET. On account of the high degree of stretching, stretch blow moulded plastic containers are superior to extrusion blow moulded plastic containers in many characteristics, such as for example mechanical strength, thermal durability, barrier characteristics. By way of this, they can often be manufactured with lower wall thicknesses than extrusion-blown plastic containers, without herein suffering a compromise of their superior characteristics.

Concerning the stretch blow moulding method, the neck region of the preform as a rule is not changed and includes an amorphous plastic, in particular PET. The neck region of non-stretched PET cannot compete with the favourable characteristics of the remaining stretched regions of the plastic bottle. In order to compensate for the worse mechanical and thermal characteristics as well as the reduced barrier characteristics at least to some extent, concerning many stretch blow moulded plastic containers the neck region has a significantly greater wall thickness compared to the remaining regions of the plastic container. This however leads to an increased material consumption and renders the manufacture of stretch blow moulded plastic containers more expensive.

In order to remedy the less favourable characteristics of the non-stretched plastic material in the neck region, it has been suggested to manufacture stretch blow moulded plastic containers in a so-called lost-neck method. Concerning this manufacturing method, which in particular is also applied for the production of plastic containers which in the neck region have a relatively larger inner diameter of for example 30 mm to 150 mm, a plastic container with a so-called dome is stretch blow moulded from a known tubular preform. The dome is cut away from the respective plastic container after the stretch blow moulding process. During the stretch blow moulding process, the desired outer contours such as for example the threaded sections, a support ring or the like are also fixed in a region directly below the dome which is to be separated away.

With the stretch blow moulding, the region in which the threaded sections and/or a support ring or the like are arranged is stretched to an extent which is similar to the remaining sections of the container. On account of the relative high stretching of the plastic material during the blow moulding, this region however can obtain such a high strength that “sharp-edged” structures such as for example threaded sections, a support ring or the like can no longer be completely blown out in the blow process. “Sharp-edged” in the context of the present disclosure is herein to be seen as structures which project from or recede into the container wall and which have a radius of curvature of up to for example 1.2 mm. The contour of the structures which are shaped out in the blow moulding method, for example of threaded sections, the contour not being blown out and not being sharp-edged enough, can lead to a screw cover not being able to be fastened to the plastic container in an adequately fixed manner.

In various applications, plastic containers, for example for reasons of sterility or also in order to improve the flow characteristics of the filled product, are filled up in a hot or at least warm manner. The containers are sealingly closed directly after the filling and the filled product cools down. In the case of plastic containers which are filled in a hot or warm manner, the sealedness of the closure can result in the container being able to deform when the filled material cools down. The deformation is a result of the pressure difference between the atmospheric pressure which acts upon the container walls from the outside and the vacuum or underpressure which arises as a result of the cooling in the interior. Thus shortly after the filling for example an overpressure can arise due to the vaporisation of the fluid, by way of gas release from the product or also by way of an increased temperature of the filled product, in the container neck or in the head space. An underpressure mostly occurs after the cooling of the container, since the gases in the head space and the filled product itself greatly change their volume, in particular this is reduced, due to the temperature difference. Additionally, an underpressure can also yet arise by way of a part of the gas which is contained in the head space dissolving in the filled product or chemically reacting with this. It can also occur that certain contents leave the container through the container wall due to migration processes and leave behind an underpressure. Thus for example the water loss with PET containers can already lie significantly above one percent after one year. With other materials such as e.g. the recently applied bio-plastics, a water loss of the specified magnitude can already occur after a shorter time.

The filling and the sale of plastic containers at different altitudes can also lead to deformation. Hence with regard to plastic containers which are filled for example at the altitude of Mexico City and are then transported to the coast and sold there, there exists the danger of a deformation due to the greater air pressure which prevails at the coast. It is particularly with plastic containers with a longitudinally extended, essentially cylindrical shape that by way of this deformations and in particular indentations can occur in the central region of their axial extension, such deformations being immediately optically recognisable as faults by the consumer. Although this deformation of the plastic containers generally has no effect on the quality of the filled product, however the external shape appearance of the article for sale is often decisive for his purchase. A plastic container which includes deformations for this reason often leads to the erroneous assumption by the customer that the product which is contained in the container no longer has the desired quality characteristics.

This tendency to deform with the cooling of the warmly or hotly filled product, although being able to be combatted by a greater wall thickness of the plastic container, however due to the increased material consumption the manufacture of these plastic containers becomes expensive and their weight increases. Solutions, concerning which stiffenings are provided along the axial extension of the plastic containers, are also known. The mechanical stiffening can necessitate specially shaped injection nozzles for manufacturing the preforms and a particular process management.

However, an increased inner pressure which occurs in the container inside in the course of time can also lead to deformations of the container. This can be the case for example with products which can outgas to a certain extent during the storage. It is possible for an increased inner pressure to occur in the plastic container given storage at high temperatures, the inner pressure being able to lead to a deformation of the plastic container, for example to a pressing-out of the container base. It is precisely a deformation in the container base region that has been found to be very disadvantageous, since the plastic container is then often no longer capable of standing.

The underpressure and overpressure which occur in the container inside can also arise due to a phase change or by way of chemical reactions. For example vitamin C can react with oxygen in the head space of the container. Different solubilities of gases in the filled liquid at different temperatures can also lead to an outgassing and hence for example to an increase of the inner pressure.

### SUMMARY

A stretch blow moulding method is disclosed for manufacturing a plastic container, the method comprising: inserting a preform configured in an essentially tubular manner with a neck part into a mould cavity of a blow moulding tool of a stretch blow moulding machine; stretching the preform with a stretching mandrel and inflating the preform in accordance with the mould cavity by way of overpressure using a fluid; separating a dome which connects onto a container section of the container, which container section is provided with at least one structure which projects or recedes with respect to a wall of the container, and which includes the neck part of the preform; and axially compressing at least one section of the structure to a settable extent within the blow moulding tool before the plastic container is removed from the mould.

### BRIEF DESCRITION OF THE DRAWINGS

Further features and advantages will be apparent to those skilled in the art from a reading of the subsequent description of exemplary embodiments, with reference to the schematic drawings. In sectioned representations as presented in the Figures, which are not true to scale, are shown:

FIG. 1 and FIG. 2 illustrate two schematic principle representations for explaining the manufacture of an exemplary stretch blow moulded plastic container with a cut neck;

FIG. 3 illustrates an axially sectioned representation of an exemplary plastic container which is located in a mould cavity before an axial compressing;

FIG. 4 illustrates the exemplary plastic container of FIG. 2 in the mould cavity after the axial compressing;

FIGS. 5 and 6 illustrate two enlarged representations of an exemplary structure in a container section before and after the axial compressing; and

FIGS. 7 and 8 illustrate two enlarged representations of an exemplary structure in a container section before the axial compressing and after the axial compressing and the releasing of the bonding.

In the schematic representations, the same elements each have the same reference numerals.

### DETAILED DESCRIPTION

The present disclosure describes exemplary embodiments of a method for modifying a stretch blow moulding method for manufacturing plastic containers, to the extent that aforementioned issues such as insufficiently sharp-edged structures on the one hand and inner pressure changes in the inside of the container on the other hand are taken into account.

The solution to these partly contradictory issues lies in a stretch blow moulding method for manufacturing plastic containers as described herein. Furthermore, a plastic container which is manufactured in a stretch blow moulding method and which includes the features specified herein also takes into account the aforementioned issues.

By way of the present disclosure, a stretch blow moulding method for manufacturing a plastic container is put forward. A preform which is designed and configured in an essentially tubular manner with a neck part is inserted into a mould cavity of a blow moulding tool of a stretch blow moulding machine and is inflated in accordance with the mould cavity by way of overpressure with the help of a fluid, and is stretched with a stretching mandrel. A blown dome which connects onto a container section which is provided with at least one structure projecting or receding with respect to the container wall, and which includes the neck part of the preform is separated away and the stretch-blown plastic container is removed from the mould. The fluid can be liquid or gaseous; for example air is applied as a blowing medium. The stretch blow moulding method is for example performed such that at least the container section which connects onto the dome and which includes the at least one structure is axially compressed to a settable extent within the mould cavity before the plastic container is removed from the mould.

The plastic container which is stretch blow moulded from a preform is for example manufactured according to the principle of the lost-neck method. Herein, the container section which includes the at least one structure which projects or recedes with respect to a container wall is stretch-strengthened to a sufficient degree. Even before the removal of the stretch blow moulded plastic container from the mould cavity, the container section which connects onto the dome and which includes the at least one structure is compressed to a settable extent. The at least one structure in the container section which connects onto the dome is firstly manufactured with a contour which has a relatively large radius of curvature. The plastic material on stretch blow moulding can be blown very easily into a recess of the mould cavity which is provided for this or blown thereabove over a projection which is correspondingly formed on the mould cavity.

The at least one recess which is formed in the outer wall of the container section or the at least one projection, with relatively large radii of curvature, is deformed with the axial compressing of the container section and by way of this obtains a sharp-edged contour. A sharp-edged contour in the context of the present disclosure herein has a radius of curvature of up to for example 1.2 mm, preferably for example up to 0.5 mm. The stretch blow moulding method according to the present disclosure hence permits the manufacture of structures, such as e.g. threaded sections, support rings, expansion or compression gaps, etc., which even with container sections which are stretch-strengthened to a greater extent can have a relatively sharp-edged contour. By way of this, such sharp-edged structures which are otherwise manufacturable only in an injection moulding method or in a flow press moulding method can be produced in a blow moulding method.

A plastic container which is stretch blow moulded in such a manner can have an advantage that it is also designed and configured in a stretch-strengthened manner to a high degree in the container sections with are provided with the structures such as e.g. threaded sections, support ring and the like. By way of this, plastic material which is otherwise used for an at least partial compensation of the insufficiently large mechanical and thermal strengths of known manufactured plastic containers can be saved. The container section with the at least one blown and compressed structure as a result of the stretch-strengthening practically has the same barrier characteristics as the remaining regions of the plastic container.

Given a suitable design and configuration of the blow moulding tool, when desired or required, further sections of the plastic container can also be axially compressed, in order to change structures which are formed there and which project or recede with respect to the container wall, with regard to the radii of curvature, in particular in order to at least temporarily reduce these in size or shape them out in a more sharply edged manner.

In an exemplary variant of the stretch blow moulding method, an axial length of the container section of the plastic container which includes the at least one structure is at least temporarily reduced by for example 1 mm to 30 mm on axially compressing. The at least temporary reduction of the plastic container can herein be effected at several locations or also at one compressing location. The axially compressed container section can be permanently axially shortened. In an exemplary alternative method variant, the axial compression of the container section can also reverse at least partly. The retraction of the axial compression or the re-assumption of the original axial length of the container section can be effected in a targeted manner, in order for example to compensate volume changes of the filled product.

In an exemplary variant of the stretch blow moulding method, a region of the container section of the plastic container which includes at least one structure, for example in the form of threaded sections, for the compressing process can be heated to a temperature which is greater than a melting temperature of the plastic from which the preform is manufactured. If the region of the container section is heated to a temperature above the melting temperature, then given an axial compressing of the container section, a material-fit connection or a welding of the pressed together wall sections occurs. With this method management, for example relatively sharp-edged and shape-stable threaded sections can be manufactured, such sections having radii of curvature which could otherwise only be manufactured in an injection moulding method or in a flow press moulding method. Apart from the threaded sections, the container section can yet also include for example a support ring or the like. By way of heating to a temperature greater than the melting temperature of the plastic, the radius of curvature of the free end of the support ring can be reduced and its shape stability increased, since on axial compressing the pressed-together wall parts are materially connected to one another or welded. The structure with walls which are materially connected to one another which is to say are welded to one another is relatively stiff and can accommodate relatively high axial and radial, tensile and compressive forces. Relatively high compressive forces can occur on stacking the containers. Given carbonated drinks, relatively high axial tensile forces can occur within the container, in combination with radial compressive forces.

In an exemplary variant of the stretch blow moulding method according to the present disclosure, a region of the container section of the plastic container which includes the at least one, for example at least regionally annularly peripheral structure, for the compressing process can be heated to a temperature which is greater than the gelation temperature and smaller than a melting temperature of the plastic from which the preform is manufactured. Given temperatures between the gelation temperature and the melting temperature of the plastic material, a bonding of the pressed-together wall parts occurs due to the axial compressing. This bonding is releasable again by way of a minimum tensile force in the magnitude of approx. 2 N per mm of bonded length. A structure manufactured in such a manner is sharp-edged, i.e. it can have a radius of curvature of up to for example 0.5 mm at its free end. The sharp-edged structure can accommodate relatively high radial forces as can occur for example in the case of the plastic containers impacting one another in a bottling facility. The plastic container also can have a relatively large grip stiffness with respect to radial forces which the consumer can apply on handling the plastic container. The structure with the bonded wall parts however is only shape stable to a limited extent since the bonding can be released again under tension. By way of this, the radius of curvature of the structure changes, which is directly evident from the outside. This can be used for example to display the deterioration of a filled product. For example, an overpressure can build up within the container due to fermentation processes, the overpressure being able to lead to a detaching of the bonded wall parts of the structure. One can also provide a structure which can serve as an integrity (first opening) indicator, concerning which the wall parts which are bonded to one another are released from one another by way of a force application on opening the container closure. The released bonding of the structure can then fulfil a hinge function and permits the container to adapt to volume changes of the filled product, for example due to temperature differences.

An exemplary embodiment variant of the stretch blow moulding method according to the present disclosure can envisage a region of the container section of the preform, the region including at least one, for example at least regionally annularly peripheral structure for the compression process, being heated to a temperature which is lower than a gelation temperature of the plastic from which the preform is manufactured. Given an axial compressing, a very easily releasable connection of the pressed-together wall parts can occur. The connection is so loose that it is already releasable by way of a very low force effort of for example only 0.9 N per mm of pressed-together length. The compressed structure fulfils a hinge function and permits the container section to very easily follow volume changes of the filled product as result of temperature differences (cooling after a hot filling or pasteurising; storage of the container in the fridge or deep-freeze).

In an exemplary variant of the stretch blow moulding method according to the present disclosure, the compressing of the container section can be effected with the help of a compression ring which forms a constituent of the blow moulding tool. The compression ring is formed by two semi-shells for example analogously to the design of the blow moulding tool with two blow mould halves, the semi-shells being unified into a compression ring given a closed blow moulding tool. It is to be understood that the blow moulding tool can yet also include further compression rings over its axial extension, these also serving to compress other regions of the plastic container, in order to influence structures which are located there with regard to their contour, in particular to reduce their radii of curvature.

Another exemplary variant of the stretch blow moulding method can envisage the compressing of the container section which connects onto the dome being effected with the help of a blow nozzle which is moved into an opening in the neck part of the preform arranged in the mould cavity. The blow moulding tool can be designed and configured more simply with this method variant.

Concerning an exemplary embodiment variant of the stretch blow moulding method, on feeding the blow mandrel which is moved into the neck part of the preform, in order to axially compress the container section which connects onto the dome, the dome can be separated away. Concerning this method variant, the axial compressing of the container section and the separating-away of the dome can be brought together into a single process step. By way of this, the cycle time for the manufacture of a plastic container can be shortened.

A method step can envisage the cut edge which is formed on the plastic container as a result of the separation of the dome, as well as the wall connecting thereto being thermally and/or mechanically treated, in order to smooth these.

Concerning an exemplary method variant, the separating-away of the dome from the plastic container can be effected in the region of a projecting structure.

The separating-away of the dome can also be effected in a manner such that the projecting structure is delimited by an upper wall which includes the cut edge, and by a lower wall. The upper and the lower wall can then be connected to one another. This can for example be effected by way of ultrasonic welding or by laser welding.

On separating away the dome, the cutting direction extends essentially transversely to the longitudinal axis of the plastic container and/or essentially along the longitudinal axis of the plastic container.

The stretch blow moulding method according to the present disclosure can be carried out on a preform which is manufactured from a plastic which includes a plastic primary component from the group including (e.g., consisting of) polyethylene terephthalate, polyethylene naphthalate, polyethylene furanoate, polylactide, their copolymers and mixtures of the mentioned plastics. The specified plastics have large similarities with respect to their processing ability. They permit high degrees of stretching and can be processed into transparent plastic containers with high strength values. The preform can be manufactured in an injection moulding method or in a flow press moulding method. One can also use a preform which has been manufactured in an extrusion blow moulding method. The preform can be designed and configured in a single-layered or multi-layered manner. The stretch blow moulding method can be carried out directly subsequently to the manufacture of the preform. The manufacture of the preform however can also be effected separately from the stretch blow moulding method with regard to location and/or time.

Up to for example at or about 20 percent by weight of foreign substances can be admixed to the plastic main component. The characteristics of the preform can be adapted to the desired demands by way of the admixing of foreign substances. For example, copolymers, dyes, UV blockers, stabilisation additives such as e.g. glass fibres or glass balls or mixtures thereof, additives or foreign polymers can be selected as foreign substances. Furthermore, the preform, apart from the plastic primary component can yet include further plastics from the group incluiding (e.g., consisting of) PEN, PEF, PLA, polyester, polyamide, polybutylene terephthalate, polycarbonate, polyolefins, silicones, their copolymers and mixtures of the mentioned plastics.

A plastic container which is manufactured according to an exemplary variant of the stretch blow moulding method according to the present disclosure includes a container section with a container opening and with a cut opening edge. The container section in its outer wall is designed and configured with thread structures which have a radius of curvature of up to for example at or about 1.2 mm, preferably for example up to at or about 0.5 mm. The plastic container which is manufactured in a stretch blow moulding method according to the lost-neck process on the one hand includes a cut neck and on the other hand a container section with threaded sections which are designed in a sharp-edged and shape-stable manner by way of axial compressing. The plastic container is also stretch-strengthened to an adequate amount in the container section with the thread structures and for this reason hence has a large mechanical and thermal shape stability as well as barrier characteristics which are comparable to those in the remaining sections of the plastic container. By way of this, the container section in which the threaded structures are formed can have a significantly lower wall thickness than conventionally stretch blow moulded plastic containers. The axially compressed threaded structures have a high shape stability and by way of this permit a reliable and sealed screwing-on of a closure.

The thread structures can be thread furrows or also threaded sections which project beyond the outer wall of the container section.

An exemplary embodiment variant of the plastic container which is manufactured according to an exemplary variant of the stretch blow moulding method according to the present disclosure includes at least one container section with at least one at least regionally annularly peripheral structure which projects with respect to an outer wall of the container section by a distance of larger than at or about for example 0.5 mm. For example, the projecting structure can be designed and configured as a support ring which at its free end has a radius of curvature which is up to at or about for example 1.2 mm, preferably up to at or about for example 0.5 mm.

In an exemplary embodiment of the plastic container, the at least one projecting structure can be delimited by an upper and a lower wall which can be releasably connected to one another. The connection of the upper and of the lower wall of the projecting structure can be releasable by a tensile force of a magnitude of for example at least at or about 0.9 N per mm length.

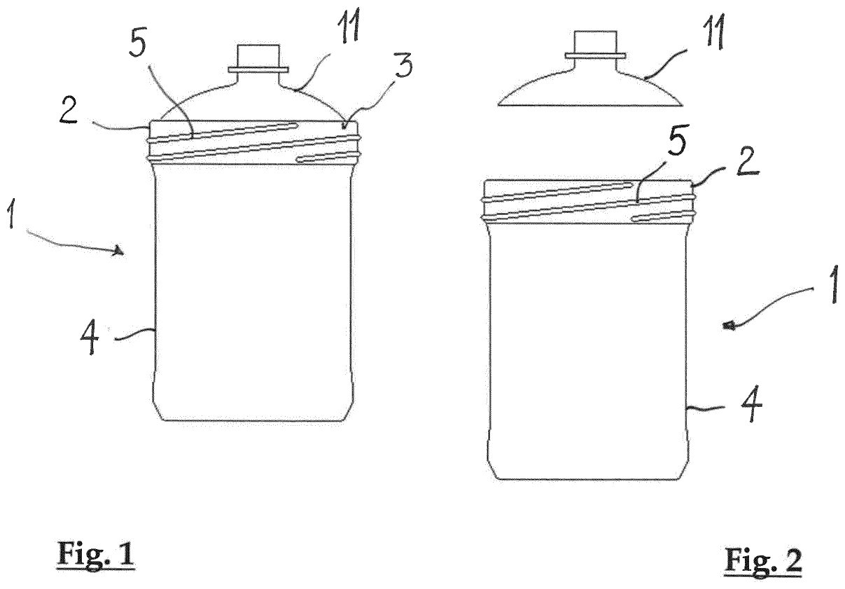

The principle representation in FIG. 1 shows a plastic container which in its entirety is indicated by the reference numeral 1 and which has been moulded in a stretch blow moulding method from a preform which is designed and configured in a standard manner and is manufactured in a plastic injection moulding method or in a flow press moulding method. Alternatively, the preform can even be manufactured in an extrusion blow moulding method. Such preforms have been known from the state of the art for some time. They can include an elongate, essentially cylindrical or slightly conically designed body. The preform body is designed and configured closed at one end. A neck part which is provided with an opening connects onto the other longitudinal end of the preform body. The neck part can be separated from the preform body by a transfer ring.

The preform can be manufactured from a plastic which includes a plastic primary component from the group including (e.g., consisting of) polyethylene terephthalate, polyethylene naphthalate, polyethylene furanoate, polylactide, their copolymers and mixtures of the mentioned plastics. The specified plastics have great similarities with regard to the processing ability. They permit high degrees of stretching and can be processed into transparent plastic containers with high strength values. The preform can be constructed in a single-layered or multi-layered manner. The plastic container can be designed and configured in a single-layered or multi-layered manner depending on the demands upon the plastic container. Herein, it has been found to be advantageous for the strength characteristics of the plastic container if at least one layer includes (e.g., consists of) a plastic or of a plastic mixture, of the group consisting of polyesters, polyolefins, polyamides, polystyrenes, polylactides and polyamides, in particular PET, PE, PP, PEN, PVC, PVDC, PLA. It can be advantageous if at least one layer includes (e.g., consists of) monomodal, bimodal or polymodal HDPE or polypropylene for the manufacture of the preform in a plastic injection moulding method or in a flow press moulding method and for the subsequent formation of the plastic container from the preform in a subsequent stretch blow moulding method. For many applications of the plastic container, in particular for the application in field of foodstuffs, it has been found to be advantageous if it is designed and configured in a multi-layered manner and includes at least one layer with barrier additives, such as for example oxygen scavengers, nano-clays or UV blockers and/or lubricative coating and/or a residual emptying coating. For ecological reasons, the plastic container according to the present disclosure can include (e.g., consist of) up to 100% of recycled plastic material (PCR plastics=post consumer regrind plastics). The stretch blow moulding method can be carried out directly subsequent to the manufacture of the preform. The manufacture of the preform can however also be effected spatially and/or temporally separately from the stretch blow moulding method.

Up to for example at about 20 percent by weight of foreign substances can be admixed to the plastic primary component. The characteristics of the preform can be adapted to the desired demands by way of the admixing foreign substances. For example, copolymers, dyes, UV blockers, stabilisation additives such as e.g. glass fibres or glass balls or mixtures thereof, additives or foreign polymers can be selected as foreign substances. Furthermore, apart from the plastic primary component, the preform can also yet include further plastics from the group consisting of PEN, PEF, PLA, polyester, polyamide, polybutylene terephthalate, polycarbonate, polyolefins, silicones, their copolymers and mixtures of the mentioned plastics.

The perform which is manufactured in the plastic injection moulding method or in the flow press moulding method is inserted into a blow moulding tool of a stretch blow moulding device and there is inflated according to a mould cavity which is enclosed by the blow moulding tool, by way of a blowing medium, such as air which is blown in at an overpressure, and is simultaneously stretched or extended with a stretching mandrel. In alternative “stretch blow moulding methods” the fluid which is brought in can also be liquid. Concerning the special lost-neck method, a region 11 of the preform which is located below the transfer ring is inflated in a dome-like widened manner. Herein, a section 2 of the plastic container 1 which forms a container neck on the finished plastic container 1 is stretched biaxially and shaped out. One or more structures which project or recede with respect to a container wall 3 can be formed on this section 2 of the plastic container 1 which connects onto the region 11 which is widened in a dome-like manner and which is connected to the neck part of the preform. In the represented embodiment example of the plastic container 1, these structures are designed and configured for example as threaded sections 5 of an outer thread. A container body 4 connects below the section 2 of the plastic container 1 which forms the container neck.

FIG. 2 shows an exemplary stretch blow moulded plastic container 1, after the region 11 which is inflated in a dome-like manner and on which the neck part of the preform which is still unchanged with the stretch blow moulding method is still evident, has been separated away. On account of the separation of the region 11 which is inflated in a dome-like manner, the stretch blow moulded plastic container 1 obtains a neck opening, whose diameter is significantly greater than that of the opening of the preform. The diameter of the opening of the cut neck section can be for example larger than at or at or about 48 mm and be up to for example 150 mm. The threaded sections which are shaped out on the cut neck section 2 of the plastic container 1 in the stretch blow moulding method are again provided with the reference numeral 5. The for example cylindrical body of the stretch blow moulded plastic container 1 has the reference numeral 4.

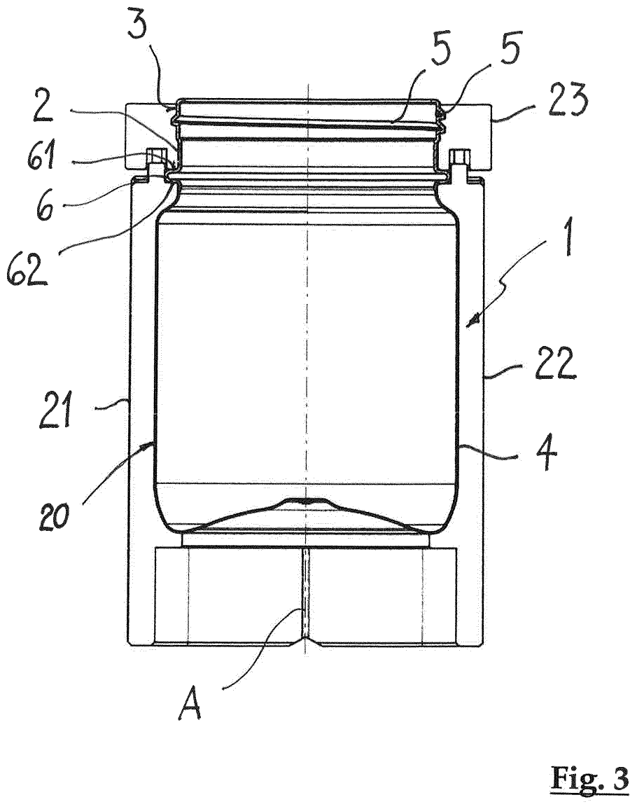

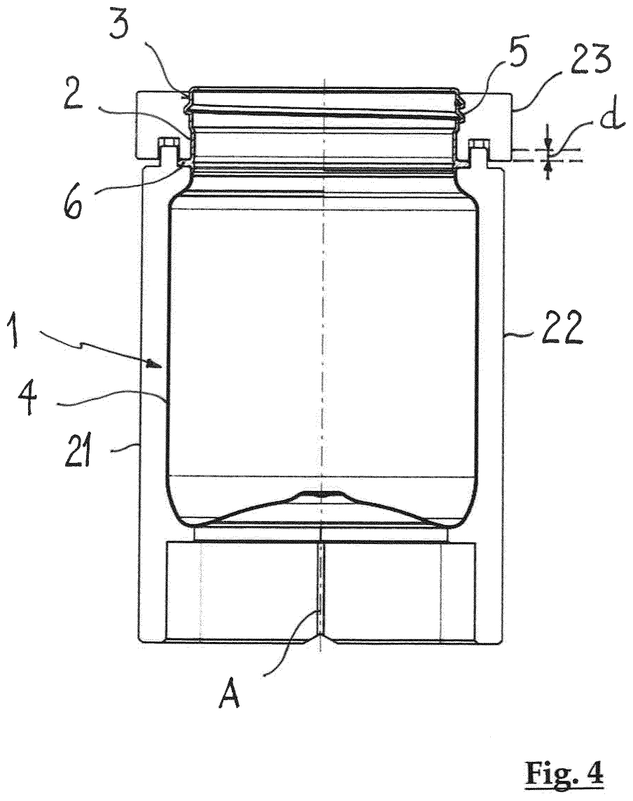

FIG. 3 schematically shows a plastic container which is located in a mould cavity 20 of a blow moulding tool 21 and which is again provided with the reference numeral 1. For reasons of a better overview, the representation of the section inflated in a dome-like manner has been omitted. The container section 2 which forms the neck of the stretch blow moulded plastic container 1 is formed with structures which for example project radially with respect to the container wall 3. Herein, one the one hand it is the case of threaded sections 5 of an outer thread, as well as a support ring 6 which is arranged between the threaded sections 5 and the body 4 of the plastic container 1. The blow moulding tool 21 has a compression ring 23 which can be fed in the axial direction A with respect to a mould base body 22. The support ring 6 is clamped in between the mould base body 22 and the compression ring 23 which is axially adjustable with respect to the mould base body 22. According to the construction of the blow moulding tool 21 of two halves of the mould base body 22, said construction being indicated in FIG. 3, the compression ring 23 can also include (e.g., consist of) two compression ring halves.

Whereas FIG. 3 shows the plastic container 1 with a compression ring 23 which is located in its initial position, said container stretch-blow moulded in the mould cavity of the blow moulding tool 21, in the schematic representation of FIG. 4 the compression ring 23 is located in its end position. For reasons of a better overview, again the representation of the section which is inflated in a dome-like manner has been omitted. The compression ring 23 was moved to the mould base body 22 by an axial distance of 1 mm to 22 mm. By way of the axial displacement of the compression ring 23 in the direction of the mould base body 2, the blown-out support ring 6 which is arranged between the compression ring 23 and the mould base body 22 is compressed. Herein, upper and lower wall parts 61, 62 which axially delimit the support ring are pressed together.

Herein, different results occur depending on the temperature of the plastic material in the region of the support ring 6. If the temperature T is larger than a melt temperature Ts of the plastic material, then a material connection or a welding of the wall parts 61, 62 occurs. By way of this, the support ring can be designed and configured in a relatively sharp-edged manner. Sharp-edged in the context of the present disclosure is herein to be understood as a radius of curvature of the free end of the support ring 6 which is up to at or about for example 1.2 mm, preferably up to at or about for example 0.5 mm. The support ring 6 with wall parts 61, 62 which are welded to one another has a high shape-stability, is relatively stiff and can accommodate relatively high axial and radial tensile and compressive forces. Alternatively, the wall parts can also be connected to one another by way of ultrasonic welding or by laser welding.

If the temperature T of the plastic material in the region of the support ring 6 is larger than a gelation temperature TG but smaller than the melting temperature Ts of the plastic material, then a bonding of the axial delimitation wall parts 6, 62 of the support ring 6 occurs. This bonding is releasable again on applying a minimum tensile force of the magnitude of for example approx. 2 N per bonded length. A support ring 6 which is manufactured in such a manner is sharp-edged, i.e. at its free end it can have a radius of curvature of up to at or about for example 1.2 mm, preferably up to at or about for example 0.5 mm. By way of this, the support ring 6 can accommodate relatively high radial forces as occur for example when the plastic containers 1 impact one another in a bottling facility. The plastic container 1 also has a relatively large grip stiffness with respect to the radial force which the consumer can exert on handling the plastic container 1. The support ring with bonded wall parts 61, 62 however is only shape-stable to a limited extent since the bonding can be released again under tension. By way of this, the radius of curvature of the structure changes, this being evident directly from the outside. This can be used for example in order to display the deterioration of a filled product. For example, an overpressure which can lead to a detachment of the bonded wall parts of the structure can build up within the container due to fermentation processes.

Alternatively or supplementarily to the support ring 6, one can for example also provide a structure which can a serve as an integrity indicator, concerning which the wall parts which are bonded to one another can be released from one another by way of applying a force on opening the container closure. The released bonding of the structure can then fulfil a hinge function and permits the plastic container 1 to be adapted to volume changes of the filled product, for example due to temperature differences.

If the temperature T of the plastic material in the region of the support ring 6 is smaller than a gelation temperature TG of the plastic material, then on axial compression only a very easily reliable connection of the pressed-together wall parts 61, 62 occurs. The connection is so loose that it is already releasable by way of a very low force application of for example only just 0.9 N per mm of pressed-together length. The compressed support ring then has a hinge function and permits the plastic container to very easily follow volume changes of the filled product as a result of temperature differences (cooling after hot filling or pasteurisation; storage of the container in the fridge or in the deep freeze).

The axial compressing of structures which project or recede in a radial manner with respect to the container wall 3 was explained by way of a support ring 6 with reference to the FIGS. 3 and 4, the support ring annularly surrounding the container wall 3 and projecting beyond it at least regionally. It is to be understood that the threaded sections 5 can also be axially compressed. For this purpose, the blow moulding tool 21 can include for example a concentric arrangement of compression ring parts which can be axially moved to one another. The threaded sections 5 can be clamped between the concentric compression ring parts.

In an exemplary alternative method procedure, the threaded sections 5 can also be compressed via a blowing nozzle which is moved into the opening of the plastic container. For the compression procedure, a radially projecting flange of the blowing nozzle then sits on the opening edge of the plastic container. This method procedure can at the same time be used to separate the dome-like region from the plastic container. Concerning the embodiment example which is represented in FIG. 3 and FIG. 4, the threaded sections 5 can then be compressed by way of the blowing nozzle which is seats itself upon the opening edge, wherein the dome-like region can be separated away at the same time. In a further sequence, the blowing nozzle can also press upon the upper side of the compression ring 23 and by way of this displace this axially to the mould base body 22. By way of this, the support ring 6 can be compressed to the desired extent.

The axial compressing of structures 5 and 6 which project or recede radially with respect to the container wall 3 is not limited to the neck section 2 of the plastic container 1 which connects onto the dome-like region. Given a suitable design of the blow moulding tool with axially displaceable compressing elements, radially projecting or receding structures in other sections of the plastic container 1, for example in the container body 4, can be axially compressed.

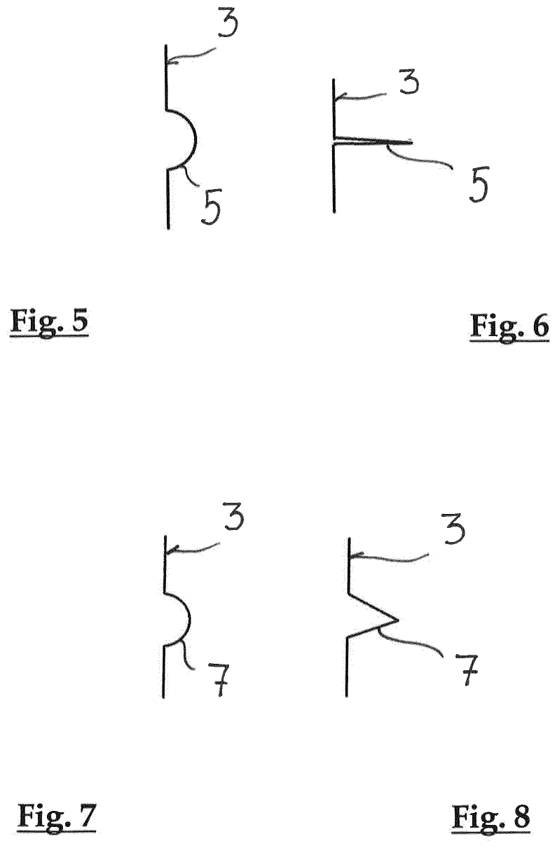

The schematic representations in FIGS. 5 and 6 serve for explaining a permanent reduction of the radius of curvature of a structure which radially projects (or recedes) with respect to the container wall 3, for example of threaded sections or an at least regionally peripheral support ring etc. For example, the represented structure is a threaded section 5. FIG. 5 shows the blown-out threaded section 5 after the blowing procedure, concerning which the plastic material has also been biaxially stretch-strengthened in the region of the thread turns 5. The radius of curvature in the thread turn 5 is relatively large. This simplifies the blowing-out of the structure. After the axial compressing procedure, the thread turn 5 which is represented in FIG. 6 has a very sharp-edged contour. Sharp-edged in the context of the present disclosure is herein seen as a radius of curvature of up to at or about for example 1.2 mm, preferably up to for example at or about 0.5 mm. The axial delimitation wall parts 61, 62 can be welded to one another.

The schematic representations in FIG. 7 and FIG. 8 show a further exemplary structure 7 which projects (or recedes) with respect to the container wall 3. The structure, for example an expansion gap is represented in FIG. 7 in the blown-out state before the compressing procedure. Again the structure 7 after the blowing procedure has a relatively large radius of curvature. FIG. 8 shows the structure 7 after the compressing procedure and after the release of any bonding between the axial delimitation wall parts 61, 62. The radius of curvature of the structure 7 is reduced. The structure 7 now has a hinge function, for example so that a container can follow volume changes of the filled product.

The aforementioned description of the specific exemplary embodiments merely serves for the explanation of the present disclosure and is not to be considered as limiting. In contrast, the present disclosure is defined by the patent claims and the equivalents which are derived by the person skilled in the art and encompassed by the general inventive concept.

It will thus be appreciated by those skilled in the art that the present disclosure can be embodied in other specific forms without departing from the spirit or essential characteristics thereof. The presently disclosed embodiments are therefore considered in all respects to be illustrative and not restricted. The scope of the present disclosure is indicated by the appended claims rather than the foregoing description and all changes that come within the meaning and range and equivalence thereof are intended to be embraced therein.

1. A stretch blow moulding method for manufacturing a plastic container, the method comprising:
inserting a preform configured in an essentially tubular manner with a neck part into a mould cavity of a blow moulding tool of a stretch blow moulding machine;
stretching the preform with a stretching mandrel and inflating the preform in accordance with the mould cavity by way of overpressure using a fluid;
separating a dome which connects onto a container section of the container, which container section is provided with at least one structure which projects or recedes with respect to a wall of the container, and which includes the neck part of the preform; and
axially compressing at least one section of the structure to a settable extent within the blow moulding tool before the plastic container is removed from the mould.

2. A stretch blow moulding method according to claim 1, wherein an axial length of the container section of the preform which includes the at least one structure is at least temporarily reduced by 1 mm to 30 mm on axially compressing.

3. A stretch blow moulding method according to claim 2, comprising:
heating a region of the container section of the plastic container which includes at least one structure having threaded sections for the compressing to a temperature which is greater than a melting temperature of the plastic from which the plastic container is manufactured.

4. A stretch blow moulding method according to claim 3, comprising:
heating a region of the container section of the plastic container which includes at least one at least regionally annularly peripheral structure for the compressing to a temperature which is greater than the gelation temperature and smaller than a melting temperature of the plastic from which the plastic container is manufactured.

5. A stretch blow moulding method according to claim 3, comprising:
heating a region of the container section of the plastic container, the region having at least one at least regionally annularly peripheral structure for the compressing, to a temperature which is lower than a gelation temperature of the plastic from which the preform is manufactured.

6. A stretch blow moulding method according to claim 3, wherein the compressing of the container section is effected with a compression ring which forms a constituent of the blow moulding tool.

7. A stretch blow moulding method according to claim 3, wherein the compressing of the container section is effected with a blow nozzle which is moved into an opening in the neck part of the preform arranged in the mould cavity.

8. A stretch blow moulding method according to claim 3, comprising:
separating the dome which includes the neck part of the preform away with the axial compressing.

9. A stretch blow moulding method according to claim 8, comprising:
thermally and/or mechanically treating a cut edge which is formed on the plastic container as a result of the separation of the dome, as well as the wall connecting thereto, in order to smooth these.

10. A stretch blow moulding method according to claim 9, wherein the separating-away of the dome from the plastic container is effected in the region of a projecting structure.

11. A stretch blow moulding method according to claim 10, wherein the separating-away of the dome is effected in a manner such that the projecting structure is delimited by an upper wall which includes the cut edge, and by a lower wall, wherein the upper and the lower wall are connected to one another by ultrasonic welding or by laser welding.

12. A stretch blow moulding method according to claim 9, wherein:
on separating away the dome;
a cutting direction extends essentially transversely to the longitudinal axis of the plastic container or essentially along the longitudinal axis of the plastic container.

13. A stretch blow moulding method according to claim 3, comprising:
manufacturing the preform from a plastic which includes a plastic primary component from the group consisting of polyethylene terephthalate, polyethylene naphthalate, polyethylene furanoate, polylactide, their copolymers and mixtures of the mentioned plastics.

14. A stretch blow moulding method according to claim 13, wherein up to 20 percent by weight of foreign substances are admixed to the plastic primary component.

15. A stretch blow moulding method according to claim 14, wherein copolymers, dyes, UV blockers, stabilisation additives of glass fibres or glass balls or mixtures thereof, additives or foreign polymers are selected as foreign substances.

16. A stretch blow moulding method according to claim 13, comprising:
manufacturing the preform from a plastic which apart from the plastic primary component yet includes plastics from the group consisting of PEN, PEF, PLA, polyester, polyamide, polybutylene terephthalate, polycarbonate, polyolefins, silicones, their copolymers and mixtures of the mentioned plastics.

17. A plastic container which is manufactured in a stretch blow moulding method according to claim 1, the plastic container comprising:
at least one container section with a container opening and with a cut opening edge, said container section in its outer wall being configured with thread structures which have a radius of curvature of at or about 1.2 mm.

18. A plastic container according to claim 17, wherein the thread structures project beyond an outer wall of the container section.

19. A plastic container manufactured in a stretch blow moulding method according to claim 1, the plastic container comprising:
a container section with at least one at least regionally annularly peripheral structure which projects with respect to an outer wall of the container section by a radial distance of larger than 0.5 mm.

20. A plastic container according to claim 19, wherein the projecting structure is configured as a support ring which at its free end has a radius of curvature which is up to at or about 1.2 mm.

21. A plastic container according to claim 20, wherein the at least one projecting structure is delimited by an upper wall and a lower wall which are releasably connected to one another.

22. A plastic container according to claim 21, wherein the connection of the upper wall and of the lower wall of the projecting structure is releasable by a tensile force of a magnitude of at least 0.9 N per mm length.
